(19) United States
(12) Patent Application Publication
(10) Pub. No.: US 2024/0059824 A1
(43) Pub. Date: Feb. 22, 2024

(54) POLYURETHANE RESIN AND METHOD FOR MANUFACTURING THE SAME

(71) Applicant: NAN YA PLASTICS CORPORATION, Taipei (TW)

(72) Inventors: TE-CHAO LIAO, TAIPEI (TW); CHENG-LI CHAO, TAIPEI (TW); Hui-Chun Chuang, TAIPEI (TW)

(21) Appl. No.: 17/993,829

(22) Filed: Nov. 23, 2022

(30) Foreign Application Priority Data
Aug. 18, 2022 (TW) 111131089

(51) Int. Cl. C08G 18/12; C08G 18/42; C08G 18/48; C08G 18/32; C08G 18/40; C08G 18/08

(52) U.S. Cl. CPC C08G 18/12; C08G 18/4238; C08G 18/4854; C08G 18/3206; C08G 18/4018; C08G 18/0852; C08G 2410/00

(57) ABSTRACT

A polyurethane resin and a method for manufacturing the same are provided. The method includes the following steps: mixing a polyester polyol, a polyether polyol, a first chain extender, diisocyanate, and a mixed solvent for polymerization, so as to obtain a prepolymer; and adding a second chain extender into the prepolymer for chain extension, so as to obtain the polyurethane resin. The mixed solvent includes diethylformamide and methyl ethyl ketone, and a mass ratio of the diethylformamide to the methyl ethyl ketone in the mixed solvent ranges from 0.45 to 1.80. Based on a total weight of the polyurethane resin being 100 wt %, a total added amount of the first chain extender and the second chain extender ranges from 0.9 wt % to 2.5 wt %.

### CROSS-REFERENCE TO RELATED PATENT APPLICATION

This application claims the benefit of priority to Taiwan Patent Application No. 111131089, filed on Aug. 18, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyurethane resin and a method for manufacturing the same, and more particularly to a polyurethane resin that can be used as a shoe material and a method for manufacturing the same.

### BACKGROUND OF THE DISCLOSURE

Polyurethane is a multifunctional high polymer material and often serves as a main raw material of artificial leather. Polyurethane resins with different hardness can be synthesized by adjusting the type and the composition of raw materials.

A conventional polyurethane resin is manufactured in a wet process. Before curing, the polyurethane resin contains an organic solvent, such as dimethylformamide (DMF). The polyurethane resin containing the dimethylformamide has good stability. However, due to a high boiling point (153° C.) of the dimethylformamide, it is necessary to vaporize the solvent at a relatively high temperature during a curing process, thereby resulting in the problem of high energy consumption. Moreover, the dimethylformamide is a controlled toxic substance. Once absorbed by the human body, the dimethylformamide cannot be easily discharged, and thus tends to cause permanent harm to the human body.

In view of the above, an issue of the conventional polyurethane resin is having a high curing temperature. Further, such polyurethane products have safety concerns, and there is the problem of not being applicable to all products in a secure manner Therefore, how to improve a manufacturing method, so as to synthesize the polyurethane resin without using the dimethylformamide and overcome the above-mentioned deficiencies, has become an important issue to be addressed in this field.

### SUMMARY OF THE DISCLOSURE

In response to the above-referenced technical inadequacies, the present disclosure provides a polyurethane resin and a method for manufacturing the same.

In one aspect, the present disclosure provides a method for manufacturing a polyurethane resin. The method includes the following steps: mixing a polyester polyol, a polyether polyol, a first chain extender, diisocyanate, and a mixed solvent for polymerization, so as to obtain a prepolymer; and adding a second chain extender into the prepolymer for chain extension, so as to obtain the polyurethane resin. The mixed solvent includes diethylformamide and methyl ethyl ketone, and a mass ratio of the diethylformamide to the methyl ethyl ketone in the mixed solvent ranges from 0.45 to 1.80. Based on a total weight of the polyurethane resin being 100 wt %, a total added amount of the first chain extender and the second chain extender ranges from 0.9 wt % to 2.5 wt %.

In some embodiments, the mixed solvent in the polyurethane resin is removed at a processing temperature between 80° C. and 110° C.

In some embodiments, an added amount of the second chain extender is 3.5 to 4.8 times an added amount of the first chain extender.

In some embodiments, based on the total weight of the polyurethane resin being 100 wt %, a content of the polyester polyol ranges from 18 wt % to 28 wt %, a content of the polyether polyol ranges from 8 wt % to 15 wt %, and a content of the diisocyanate ranges from 3 wt % to 10 wt %.

In some embodiments, the method further includes: adding methyl ethyl ketone into the polyurethane resin after the chain extension, so that a mass ratio of the diethylformamide to the methyl ethyl ketone in the polyurethane resin ranges from 0.09 to 0.35.

In some embodiments, a solid content of the polyurethane resin ranges from 38% to 45%.

In another aspect, the present disclosure provides a polyurethane resin, which is manufactured by the aforementioned method.

In some embodiments, the polyester polyol is synthesized by polymerizing adipic acid and butanediol. The polyether polyol is a straight-chain polyether polyol, and a molecular chain of the straight-chain polyether polyol has primary hydroxyl groups at both ends thereof.

In some embodiments, the polyurethane resin includes a soft chain segment and a hard chain segment, a proportion of the soft chain segment ranges from 75 wt % to 85 wt %, and a proportion of the hard chain segment ranges from 15 wt % to 25 wt %.

In some embodiments, a viscosity of the polyurethane resin ranges from 20,000 cps to 30,000 cps.

In some embodiments, a weight-average molecular weight of the polyurethane resin ranges from 90,000 g/mol to 110,000 g/mol.

In some embodiments, a peel strength of the polyurethane resin upon curing relative to a polyurethane substrate ranges from 12.0 kg/cm³ to 18.0 kg/cm³.

One of the beneficial effects of the present disclosure is that, in the polyurethane resin and the method for manufacturing the same provided by the present disclosure, by virtue of “a mass ratio of the diethylformamide to the methyl ethyl ketone in the mixed solvent ranging from 0.45 to 1.80” and “a total added amount of the first chain extender and the second chain extender ranging from 0.9 wt % to 2.5 wt %,” the polyurethane resin can have an improved processability, an improved flex resistance, and an improved peel strength.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a polyurethane resin according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to solve the above-mentioned problems, the present disclosure provides a method for manufacturing a polyurethane resin. During a manufacturing process, dimethylformamide is not used, thereby reducing a threat of product toxicity to the human body. Further, the obtained polyurethane resin has advantages of a good processability, an excellent flex resistance, and a high peel strength, which can meet property requirements of the polyurethane resin that is applied to shoe materials currently on the market.

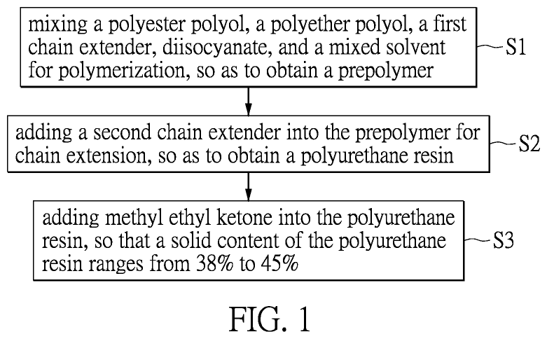

Referring to FIG. 1, the method of the present disclosure includes the following steps: mixing a polyester polyol, a polyether polyol, a first chain extender, diisocyanate and a mixed solvent for polymerization, so as to obtain a prepolymer (step S1); adding a second chain extender into the prepolymer for chain extension, so as to obtain the polyurethane resin (step S2); and adding methyl ethyl ketone into the polyurethane resin, so that a solid content of the polyurethane resin ranges from 38% to 45% (step S3).

Solid components for forming the polyurethane resin include: the polyester polyol, the polyether polyol, chain extenders (i.e., the first chain extender and the second chain extender), and the diisocyanate. Based on a total weight of the solid components in the polyurethane resin being 100 wt %, a content of the polyester polyol ranges from 48 wt % to 63 wt %, a content of the polyether polyol ranges from 20 wt % to 30 wt %, a content of the chain extenders ranges from 1.5 wt % to 8 wt %, and a content of the diisocyanate ranges from 10 wt % to 20 wt %.

The polyurethane resin of the present disclosure includes a soft chain segment and a hard chain segment, the soft chain segment is composed of the polyester polyol and the polyether polyol, and the hard chain segment is composed of the diisocyanate and the chain extenders. Blending of the soft chain segment and the hard chain segment enables the polyurethane resin to possess an improved flex resistance.

In one exemplary embodiment, a weight proportion of the soft chain segment is higher than a weight proportion of the hard chain segment. Specifically, based on the total weight of the solid components in the polyurethane resin being 100 wt %, the polyurethane resin includes 75 wt % to 85 wt % of the soft chain segment and 15 wt % to 25 wt % of the hard chain segment. In this way, the polyurethane resin has good physical properties after polymerization, and can be applied to the shoe materials.

In one exemplary embodiment, the polyester polyol is an adipic acid-based polyester polyol. For example, monomers for synthesizing the polyester polyol may include adipic acid and butanediol, and the polyester polyol has a number-average molecular weight ranging from 1,000 g/mol to 3,000 g/mol, a hydroxyl value ranging from 35 to 39, and an acid value ranging from 0.4 to 0.6. However, the present disclosure is not limited thereto.

In one exemplary embodiment, the polyester polyol is a straight-chain polyester polyol, and has primary hydroxyl groups at molecular ends thereof. For example, the polyether polyol can be polytetramemethylene ether glycol (with a number-average molecular weight of 1,000 g/mol to 3,000 g/mol) or polypropylene glycol (with a number-average molecular weight of 1,000 g/mol to 4,000 g/mol), and the polyether polyol has a number-average molecular weight ranging from 1,000 g/mol to 4,000 g/mol. However, the present disclosure is not limited thereto.

In one exemplary embodiment, the first chain extender and the second chain extender are each independently selected from the group consisting of ethylene glycol, 1,4-butanediol and 1,6-hexanediol. The first chain extender and the second chain extender may be the same as or different from each other. In one exemplary embodiment, the first chain extender is the same as the second chain extender.

In one exemplary embodiment, the diisocyanate can be selected from the group consisting of methylenediphenyl diisocyanate (MDI), toluene diisocyanate (TDI) and isophorone diisocyanate (IPDI). However, the present disclosure is not limited thereto.

In the present disclosure, the chain extenders are added in step S1 and step S2, respectively. Further, an added amount of the second chain extender is controlled to be greater than an added amount of the first chain extender. In this way, the flex resistance of the polyurethane resin can be improved. In one exemplary embodiment, the added amount of the second chain extender is 3.5 to 4.8 times the added amount of the first chain extender. Specifically, the added amount of the second chain extender may be 3.6 times, 3.8 times, 4.0 times, 4.2 times, 4.4 times or 4.6 times the added amount of the first chain extender.

In the present disclosure, by adding the chain extenders in a stepwise manner, the polyurethane resin is allowed to possess an improved processability, an improved peel strength, and an improved flex resistance. The addition of the first chain extender can properly increase a molecular chain length of the polyurethane resin. The addition of the second chain extender further enables the polyurethane resin to possess a desirable molecular chain length, and improves the processability, the peel strength and the flex resistance of the polyurethane resin.

It should be noted that, when the added amount of the second chain extender is too low, the structural strength of the polyurethane resin is insufficient, which will negatively affect the processability, the peel strength and the flex resistance of the polyurethane resin. Specifically, based on a total weight of the polyurethane resin (including the solid components and liquid components) being 100 wt %, the added amount of the first chain extender may range from 0.2 wt % to 0.6 wt %, and the added amount of the second chain extender may range from 0.9 wt % to 2.5 wt %.

In order to polymerize the desired polyurethane resin, the timing of adding the second chain extender will also affect the properties of the polyurethane resin. In one exemplary embodiment, when a content of an isocyanate group (—NCO) in the prepolymer ranges from 1.0 wt % to 2.0 wt %, the second chain extender is added into the prepolymer to carry out step S2.

On the other hand, in order to enable the solid components (i.e., the polyester polyol, the polyether polyol, the chain extenders, and the diisocyanate) to possess good compatibility and reactivity, diethylformamide and methyl ethyl ketone are selected as solvents (i.e., the liquid components) in the present disclosure for replacing the toxic dimethylformamide.

During the polymerization (steps S1 and S2), the addition of the diethylformamide can improve the compatibility and reactivity of the polyurethane resin, but too much or too little diethylformamide will negatively affect the compatibility and physical properties of the polyurethane resin. Therefore, in the present disclosure, the solid content of the polyurethane resin is adjusted by controlling an added amount of the diethylformamide and mixing with an appropriate amount of the methyl ethyl ketone, so as to facilitate the polymerization.

In one exemplary embodiment, a mass ratio of the diethylformamide to the methyl ethyl ketone in the mixed solvent ranges from 0.45 to 1.80. Specifically, the mass ratio of the diethylformamide to the methyl ethyl ketone in the mixed solvent can be a value between 0.45 and 1.80 (e.g., 0.45, 0.50, 0.55 . . . 1.70, 1.75, 1.80) in an arithmetic progression with a common difference of 0.05.

Specifically, based on the total weight of the polyurethane resin (including the solid components and the liquid components) being 100 wt %, the added amount of the diethylformamide ranges from 5 wt % to 16 wt %. For example, the added amount of the diethylformamide may be 6 wt %, 8 wt %, 10 wt %, 12 wt % or 14 wt %.

It should be noted that the methyl ethyl ketone added in step S1 can keep the solid content of the polyurethane resin maintained at a concentration that is conducive to the reaction. The methyl ethyl ketone added in step S3 can adjust the solid content of the polyurethane resin to be between 38% to 45%. Moreover, the addition of the methyl ethyl ketone can lower an evaporation temperature of the solvents in the polyurethane resin, thereby reducing energy consumption for curing the polyurethane resin. To be specific, the solvents (i.e., the methyl ethyl ketone and the diethylformamide) in the polyurethane resin can be removed at a processing temperature between 80° C. and 110° C.

Specifically, based on the total weight of the polyurethane resin (including the solid components and the liquid components) being 100 wt %, an added amount of the methyl ethyl ketone in step S1 ranges from 6 wt % to 12 wt %, and the added amount of the methyl ethyl ketone in step S3 ranges from 32 wt % to 45 wt %. A total added amount of the methyl ethyl ketone in the polyurethane resin ranges from 40 wt % to 60 wt %.

In order to demonstrate the advantages of the polyurethane resin of the present disclosure (i.e., having a good processability, an excellent flex resistance, and a high peel strength), polyurethane resins are prepared in Examples 1 to 4 (E1 to E4) and Comparative Examples 1 to 3 (C1 to C3) according to the following steps, and specific added amounts of the components are shown in Table 1.

In step S1, the adipic acid-based polyester polyol (i.e., the polyester polyol), the polytetramemethylene ether glycol (i.e., the polyether polyol), the 1,6-hexanediol (i.e., the first chain extender), and the mixed solvent (i.e., N,N-diethylformamide (DEF) and the methyl ethyl ketone (MEK)) are added into a reaction tank and heated to 70° C. with continuous stirring. Then, diphenylmethane diisocyanate (i.e., the diisocyanate) and a small amount of a catalyst are added into the reaction tank. Such a mixture is heated to 78° C. and reacted for 2 hours, so as to obtain the prepolymer.

In step S2, the 1,6-hexanediol (i.e., the second chain extender) is added into the prepolymer, and the reaction proceeds for 1 hour at 78° C., so as to obtain the polyurethane resin.

In step S3, after the polyurethane resin is cooled below 45° C., the methyl ethyl ketone is added to dilute the polyurethane resin, so that the solid content of the polyurethane resin ranges from 38% to 45% (preferably 39% to 41%).

After the preparation, the polyurethane resins in Examples 1 to 4 (E1 to E4) and Comparative Examples 1 to 3 (C1 to C3) are each subjected to tests of viscosity, weight-average molecular weight, processability, peel strength and flex resistance.

The viscosity is measured with a viscosimeter (brand: BROOKFIELD; model: DV-E). The weight-average molecular weight is measured with a gel permeation analyzer (brand: SHIMADZU; model: LC-40XR). The processability refers to assessing whether or not a coating property is abnormal at the processing temperature between 80° C. and 110° C. If there is no abnormality, the processability is denoted by “OK”; and if there are abnormal defects, the processability is denoted by “NG”. The peel strength is measured with a universal tensile testing machine (brand: SHIMADZU; model: AG-X). A room-temperature flex resistance is assessed with a flex resistance testing machine (brand: GOTECH; model: GT-7006-V50) by performing 100,000 flex tests at an angle of 22.5°, a frequency of 100 tests/min and a temperature of 25° C. If the appearance does not show abnormal defects or damage, the room-temperature flex resistance is denoted by “OK”; and if the appearance shows abnormal defects and damage, the room-temperature flex resistance is denoted by “NG”. A low-temperature flex resistance is assessed with the flex resistance testing machine (brand: GOTECH; model: GT-7006-V50) by performing 10,000 flex tests at an angle of 22.5°, a frequency of 100 tests/min and a temperature of −10° C. If the appearance does not show abnormal defects or damage, the low-temperature flex resistance is denoted by “OK”; and if the appearance shows abnormal defects and damage, the low-temperature flex resistance is denoted by “NG”.

TABLE 1

| Polyurethane resin | | | E1 | E2 | E3 | E4 | C1 | C2 | C3 |
|---|---|---|---|---|---|---|---|---|---|
| Solid | Polyester polyol (wt %) | | 24.1 | 21.6 | 21.5 | 20.3 | 23 | 21.5 | 20.6 |
| components | Polyether polyol (wt %) | | 9.5 | 10.9 | 10.8 | 10.2 | 11.5 | 10.8 | 10.4 |
| | First chain extender | | 0.2 | 0.3 | 0.3 | 0.5 | 0.2 | 0.3 | 0.4 |
| | (wt %) | | | | | | | | |
| | Second chain extender | | 0.9 | 1.2 | 1.4 | 1.8 | 0.6 | 1.4 | 1.7 |
| | (wt %) | | | | | | | | |
| | Diisocyanate (wt %) | | 5.4 | 6.1 | 6.5 | 7.4 | 5.0 | 6.5 | 7.0 |
| Weight proportions of polyester | | | 60.1/23.7/ | 53.9/27.2/ | 53.1/26.7/ | 50.5/25.4/ | 57.1/28.5/ | 53.1/26.7/ | 51.4/25.9/ |
| polyol/polyether | | | 13.5/2.7 | 15.2/3.7 | 16.0/4.2 | 18.4/5.7 | 12.4/2.0 | 16.0/4.2 | 17.5/5.2 |
| polyol/diisocyanate/chain | | | | | | | | | |
| extender | | | | | | | | | |
| Liquid | Mixed | Diethyl- | 5.4 | 9.1 | 12.7 | 15.4 | 12.7 | 4.4 | 16.2 |
| components | solvent | formamide | | | | | | | |
| | | (wt %) | | | | | | | |
| | | Methyl ethyl | 10.9 | 10.2 | 9.4 | 8.9 | 9.4 | 11 | 8.7 |
| | | ketone (wt %) | | | | | | | |

| | Methyl ethyl ketone | 43.6 | 40.6 | 37.4 | 35.5 | 37.6 | 44.1 | 35 |
|---|---|---|---|---|---|---|---|---|
| | (wt %) added in step S3 | | | | | | | |
| Mass ratio of DEF to MEK in the | | 0.50 | 0.89 | 1.35 | 1.73 | 1.35 | 0.40 | 1.86 |
| mixed solvent | | | | | | | | |
| Total mass ratio of DEF to MEK | | 0.10 | 0.18 | 0.27 | 0.35 | 0.27 | 0.08 | 0.37 |
| in the polyurethane resin | | | | | | | | |
| Properties | Viscosity (cps) (25° C.) | 25,840 | 26,780 | 27,340 | 29,490 | 22,950 | 24,670 | 28,870 |
| | Weight-average | 93,447 | 101,100 | 104,507 | 108,479 | 83,630 | 87,740 | 105,500 |
| | molecular weight | | | | | | | |
| | (g/mol) | | | | | | | |
| | Processability | OK | OK | OK | OK | NG | NG | NG |
| | Peel strength (kg/cm³) | 12.6 | 13.8 | 15.1 | 14.6 | 10.8 | 11.6 | 11.8 |
| | Room-temperature flex | OK | OK | OK | OK | NG | NG | NG |
| | resistance (25° C.) | | | | | | | |
| | Low-temperature flex | OK | OK | OK | OK | NG | NG | NG |
| | resistance (−10° C.) | | | | | | | |

It can be observed from the results of Table 1 that the polyurethane resins of the present disclosure have a good processability, the solvents can be removed at the processing temperature between 80° C. and 110° C., and a good coating flatness can be achieved. The polyurethane resins of the present disclosure have flex resistance in both room-temperature and low-temperature environments, and can withstand 100,000 flex tests at a room temperature (25° C.) and 10,000 flex tests at a low temperature (−10° C.).

The polyurethane resins of the present disclosure have a peel strength of greater than 12 kg/cm³. Specifically, the peel strength of the polyurethane resins relative to a polyurethane substrate may range from 12.0 kg/cm³ to 18.0 kg/cm³. That is to say, the polyurethane resins have a good bonding strength relative to the polyurethane material.

In addition, the viscosity of the polyurethane resins of the present disclosure may range from 20,000 cps to 30,000 cps, and preferably range from 25,000 cps to 30,000 cps. The weight-average molecular weight of the polyurethane resins of the present disclosure may range from 90,000 g/mol to 110,000 g/mol, and preferably range from 92,000 g/mol to 109,000 g/mol. However, the present disclosure is not limited thereto.

It can be observed from the content of Comparative Example 1 that, when added concentrations of the chain extenders (i.e., the first chain extender and the second chain extender) are insufficient (less than 0.9 wt %), the polyurethane resins of the present disclosure cannot be obtained. Preferably, the added concentration of the second chain extender ranges from 0.9 wt % to 2.5 wt %.

It can be observed from the content of Comparative Examples 2 and 3 that, the mass ratio of the diethylformamide to the methyl ethyl ketone in the mixed solvent affects the properties of the polyurethane resins. When the mass ratio of the diethylformamide to the methyl ethyl ketone is less than 0.9 wt % (Comparative Example 2) or greater than 1.8 wt % (Comparative Example 3), the polyurethane resins of the present disclosure cannot be obtained.

### BENEFICIAL EFFECTS OF THE EMBODIMENTS

One of the beneficial effects of the present disclosure is that, in the polyurethane resin and the method for manufacturing the same provided by the present disclosure, by virtue of “a mass ratio of the diethylformamide to the methyl ethyl ketone in the mixed solvent ranging from 0.45 to 1.80” and “a total added amount of the first chain extender and the second chain extender ranging from 0.9 wt % to 2.5 wt %,” the polyurethane resin can have an improved processability, an improved flex resistance, and an improved peel strength.

Further, by virtue of “the mixed solvent including diethylformamide and methyl ethyl ketone,” an effect of improving the compatibility and reactivity among the solid components of the polyurethane resin can be achieved in the present disclosure, and the polyurethane resin is allowed to possess a good processability.

Further, by virtue of “an added amount of the second chain extender being 3.5 to 4.8 times an added amount of the first chain extender,” the processability, the flex resistance, and the peel strength of the polyurethane resin can be improved.

Further, by virtue of “adding methyl ethyl ketone into the polyurethane resin after the chain extension, so that a mass ratio of the diethylformamide to the methyl ethyl ketone in the polyurethane resin ranges from 0.09 to 0.35,” the processability of the polyurethane resin can be improved in the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a polyurethane resin, comprising:
mixing a polyester polyol, a polyether polyol, a first chain extender, diisocyanate and a mixed solvent for polymerization, so as to obtain a prepolymer; wherein the mixed solvent includes diethylformamide and methyl ethyl ketone, and a mass ratio of the diethylformamide to the methyl ethyl ketone in the mixed solvent ranges from 0.45 to 1.80; and
adding a second chain extender into the prepolymer for chain extension, so as to obtain the polyurethane resin;
wherein, based on a total weight of the polyurethane resin being 100 wt %, a total added amount of the first chain extender and the second chain extender ranges from 0.9 wt % to 2.5 wt %.

2. The method according to claim 1, wherein the mixed solvent in the polyurethane resin is removed at a processing temperature between 80° C. and 110° C.

3. The method according to claim 1, wherein an added amount of the second chain extender is 3.5 to 4.8 times an added amount of the first chain extender.

4. The method according to claim 1, wherein, based on the total weight of the polyurethane resin being 100 wt %, a content of the polyester polyol ranges from 18 wt % to 28 wt %, a content of the polyether polyol ranges from 8 wt % to 15 wt %, and a content of the diisocyanate ranges from 3 wt % to 10 wt %.

5. The method according to claim 1, further comprising: adding methyl ethyl ketone into the polyurethane resin after the chain extension, so that a mass ratio of the diethylformamide to the methyl ethyl ketone in the polyurethane resin ranges from 0.09 to 0.35.

6. The method according to claim 5, wherein a solid content of the polyurethane resin ranges from 38% to 45%.

7. A polyurethane resin, characterized in that the polyurethane resin is manufactured by the method as claimed in claim 1.

8. The polyurethane resin according to claim 7, wherein the polyester polyol is synthesized by polymerizing adipic acid and butanediol; wherein the polyether polyol is a straight-chain polyether polyol, and a molecular chain of the straight-chain polyether polyol has primary hydroxyl groups at both ends thereof.

9. The polyurethane resin according to claim 7, wherein the polyurethane resin includes a soft chain segment and a hard chain segment, a proportion of the soft chain segment ranges from 75 wt % to 85 wt %, and a proportion of the hard chain segment ranges from 15 wt % to 25 wt %.

10. The polyurethane resin according to claim 7, wherein a viscosity of the polyurethane resin ranges from 20,000 cps to 30,000 cps.

11. The polyurethane resin according to claim 7, wherein a weight-average molecular weight of the polyurethane resin ranges from 90,000 g/mol to 110,000 g/mol.

12. The polyurethane resin according to claim 7, wherein a peel strength of the polyurethane resin upon curing relative to a polyurethane substrate ranges from 12.0 kg/cm³ to 18.0 kg/cm³.
